(19) United States
(12) Patent Application Publication
(10) Pub. No.: US 2018/0073600 A1
(43) Pub. Date: Mar. 15, 2018

(54) CONTINUOUSLY VARIABLE RATIO TRANSMISSION

(71) Applicant: FORD GLOBAL TECHNOLOGIES, LLC, Dearborn, MI (US)

(72) Inventors: MARK A. LIPPMAN, NEW BALTIMORE, MI (US); MANGALA A. JAYASURIYA, BLOOMFIELD HILLS, MI (US)

(21) Appl. No.: 15/262,621

(22) Filed: Sep. 12, 2016

(51) Int. Cl. F16H 3/64; F16H 3/54

(52) U.S. Cl. CPC F16H 3/64; F16H 2200/2007; F16H 2200/2005; F16H 3/54

(57) ABSTRACT

An automotive transmission comprises first and second gears, planetary gears, and a ring gear. The first gear is rotatable about a first axis. Shafts are radially slidable on the first gear and extend axially parallel to the first axis. The second gear is rotatable about a second axis. The second axis is parallel to, and at a fixed offset from, the first axis. Each of the planetary gears is mounted on and rotatable about a respective one of the shafts. The planetary gears mesh with the second gear. The ring gear is coaxial with the second gear and has teeth that selectively mesh with less than all of the planetary gears at a time. The teeth are adjustable to change a distance from the axis to the teeth to changeably set a gear ratio between the first and second gears.

### BACKGROUND OF INVENTION

The present invention relates to automotive transmissions and in particular to a continuously variable ratio transmission having a fixed offset between input and output gears.

An automotive transmission is part of a powertrain of an automotive vehicle and provides a plurality of gear ratios between an input, such as an internal combustion engine, and an output, such as driven wheels of the vehicle. The transmission may be of a continuously variable ratio type that uses a belt and pulleys to continuously change the gear ratios in a known manner. However, the belt and pulleys type of transmissions require packaging space to accommodate two side by side pulleys, both of which have the largest outside diameter to achieve a desired range for the gear ratios. The two pulleys also each require control hardware that increases complexity of the transmission. The belt, two pulleys, and control hardware also contribute weight to the vehicle.

### SUMMARY OF INVENTION

An embodiment contemplates a transmission. A first gear is rotatable about an axis. Shafts are slidable on the first gear. Each of the shafts extends axially parallel to the axis. A second gear is rotatable about a second axis parallel to, and at a fixed offset from, the axis. Planetary gears mesh with the second gear. Each planetary gear is mounted on, and rotatable about, a respective one of the shafts. A ring gear is coaxial with the second gear and has teeth. The teeth selectively mesh with less than all of the planetary gears at a time and are adjustable to change a distance from the axis to the teeth to changeably set a gear ratio between the first and second gears.

Another embodiment contemplates a transmission. A first gear rotatable about a first axis. Spokes extend radially from the first gear. Shafts each extend axially parallel to the first axis and are each mounted on, and radially slidable on, a respective one of the spokes. A second gear is rotatable about a second axis. The second axis is parallel to, and at a fixed offset from, the first axis. Planetary gears are each mounted on, and rotatable about, a respective one of the shafts. The planetary gears mesh with the second gear. A ring gear is coaxial with the second gear and has teeth. The ring gear is rotated to selectively mesh the teeth with less than all of the planetary gears at a time and to change a distance from the first axis to the teeth to changeably set a gear ratio between the first and second gears.

Another embodiment contemplates a transmission. A first gear is rotatable about a first axis. Spokes extend radially from the first gear. Shafts each extend axially parallel to the first axis and are each mounted on, and radially slidable on, a respective one of the spokes. A second gear is rotatable about a second axis. The second axis is parallel to, and at a fixed offset from, the first axis. Planetary gears are each mounted on, and rotatable about, a respective one of the shafts. The planetary gears mesh with the second gear. A rotationally fixed ring gear is coaxial with the second gear and has teeth. The teeth each have an extended position in which the teeth mesh with the planetary gears and a retracted position in which the teeth do not mesh with the planetary gears. A controller is configured to selectively extend and retract selective teeth to selectively mesh the teeth with less than all of the planetary gears at a time to change a distance from the first axis to the teeth to changeably set a gear ratio between the first and second gears.

Another embodiment contemplates a transmission. A first spoke gear is rotatable about a first axis. First shafts each extend axially parallel to the first axis and are radially slidable on the first spoke gear. A first spur gear is rotatable about a second axis. The second axis is parallel to, and at a fixed offset from, the first axis. First planetary gears are each mounted on, and rotatable about, a respective one of the first shafts. The first planetary gears mesh with the first spur gear. A first ring gear is coaxial with the first spur gear and has first teeth. The first teeth selectively mesh with less than all of the first planetary gears at a time and are adjustable to change a first distance from the first axis to the first teeth to changeably set a first gear ratio between the first spoke gear and first spur gear. A second spoke gear is rotatable about the second axis. Second shafts each extend axially parallel to the second axis and are radially slidable on the second spoke gear. A second spur gear is rotatable about a third axis. The third axis is parallel to, and at a fixed offset from, the second axis. Second planetary gears are each mounted on, and rotatable about, a respective one of the second shafts. The second planetary gears mesh with the second spur gear. A second ring gear is coaxial with the second spur gear and has second teeth. The second teeth selectively mesh with less than all of the second planetary gears at a time and are adjustable to change a second distance from the second axis to the second teeth to changeably set a second gear ratio between the second spoke gear and second spur gear. The second spoke gear drives the first spur gear. An overall gear ratio for the transmission is a product of the first and second gear ratios.

Another embodiment contemplates a transmission. A first gear is on a first shaft and a second gear is on a second shaft. The second shaft is at a parallel, fixed offset from the first shaft. Planetary gears are slidably mounted on the first gear and rotatably mesh with the second gear. A ring gear is coaxial with the first gear and has teeth. The ring gear is rotated to selectively mesh the teeth with the planetary gears and change a distance from the first shaft to the teeth.

An advantage of an embodiment is a continuously variable ratio transmission with reduced packaging space requirements. Further advantages are reduced complexity and weight for the continuously variable ratio transmission.

### BRIEF DESCRIPTION OF DRAWINGS

FIG. 1 is a schematic view of an automotive powertrain including a continuously variable ratio transmission.

FIG. 2 is a perspective view of a portion of the transmission of FIG. 1.

FIG. 3 is a second perspective view of a portion of the transmission of FIG. 1.

FIG. 4 is a partial, exploded perspective view of the transmission of FIG. 1.

FIG. 5 is a partial perspective view of the transmission of FIG. 1.

FIG. 6 shows a first position of a portion of the transmission of FIG. 1.

FIG. 7 shows a second position of a portion of the transmission of FIG. 1.

FIG. 8 is a graph of a mode of operation of the transmission of FIG. 1.

FIG. 9 is a graph of an additional mode of operation of the transmission of FIG. 1.

FIG. 10 is a partial perspective view of the transmission of FIG. 1.

FIG. 11 is a partial perspective view of the transmission of FIG. 1.

FIG. 12 is a partial perspective view of the transmission of FIG. 1.

FIG. 13 is a partial perspective view of a second embodiment of a continuously variable ratio transmission.

FIG. 14 is a partially exploded perspective view of a third embodiment showing a portion of a continuously variable ratio transmission.

FIG. 15 is a view of the transmission of FIG. 14 from a different perspective.

FIG. 16 is a perspective view of a fourth embodiment showing a portion of a continuously variable ratio transmission.

FIG. 17 is a partial elevation view of the transmission of FIG. 16.

FIG. 18 is a partial perspective view of a fifth embodiment showing a portion of a continuously variable ratio transmission.

FIG. 19 is a perspective view of a sixth embodiment showing a portion of a continuously variable ratio transmission in accordance with the present invention.

### DETAILED DESCRIPTION

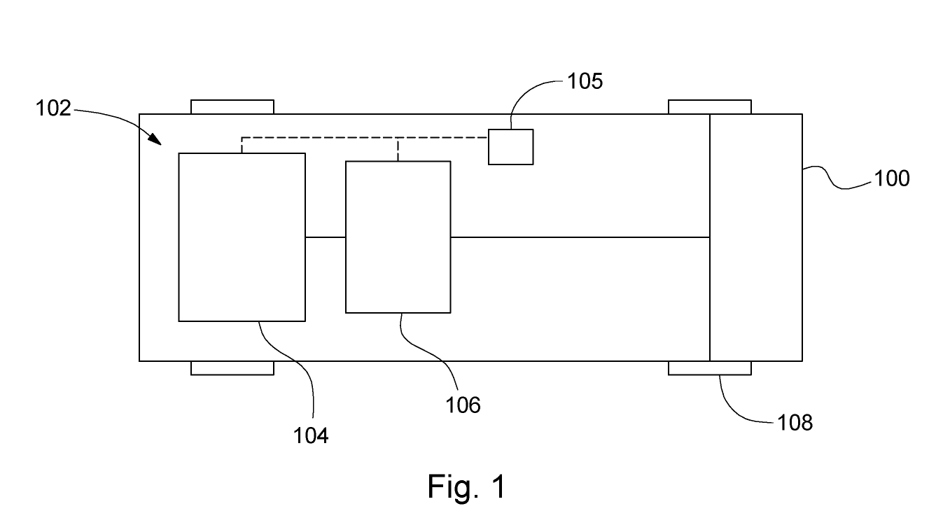

FIG. 1 illustrates a vehicle 100 having an automotive powertrain, indicated generally at 102. The powertrain 102 comprises a power source 104 powering a continuously variable ratio transmission (CVRT), indicated generally at 106, which in turn powers driven wheels 108. The power source 104 may be, for example, an internal combustion engine and/or an electric motor. The power source 104 and the transmission 106 may be controlled by one or more controllers 105, which may be made up of various combinations of software and hardware, as is known in the art.

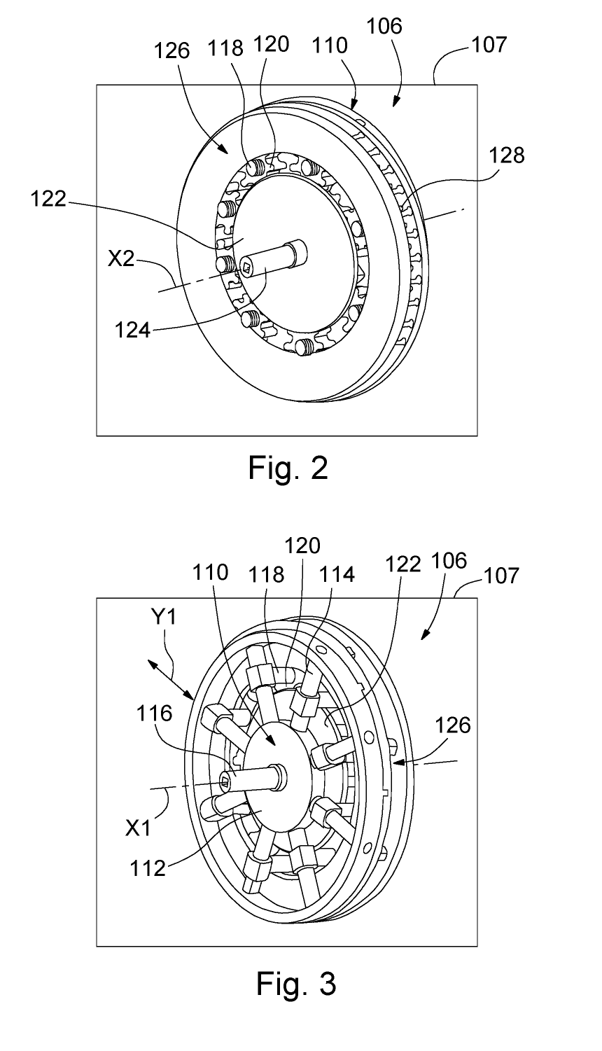

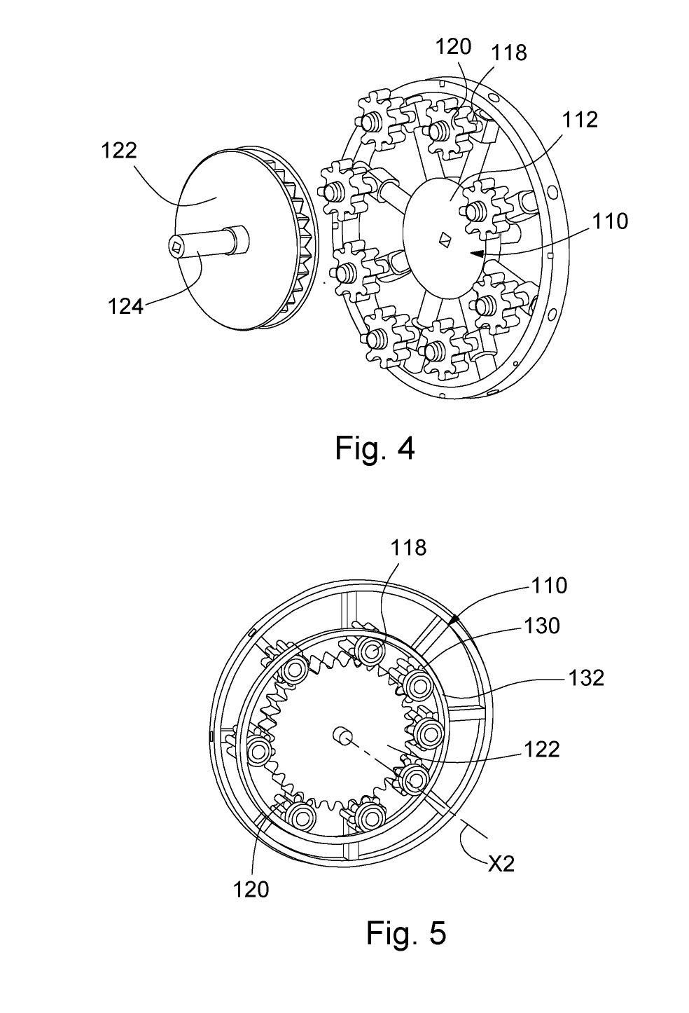

FIGS. 2-4 illustrate details of the transmission 106 in a housing 107. The transmission 106 has a first or spoke gear, indicated generally at 110. The first gear 110 rotates about a first axis X1 and has a hub 112. The first gear includes a plurality of spokes 114 extending radially from the hub 112. Extending axially from the hub 112 is a first shaft 116, which may be supported for rotation by bearings (not illustrated). The first shaft 116 may be an output shaft for the transmission 106 sending power to the driven wheels 108.

A plurality of support shafts, indicated generally at 118, have bases that are mounted on the spokes 114 such that one of the support shafts 118 is mounted on each of the spokes 114. The support shafts 118 are mounted on the spokes 114 such that the support shafts 118 are free (when not otherwise constrained) to slide or translate radially along a length of the spokes 114 in a direction Y1. For example, bushings may allow the support shafts 118 to slide along the spokes 114.

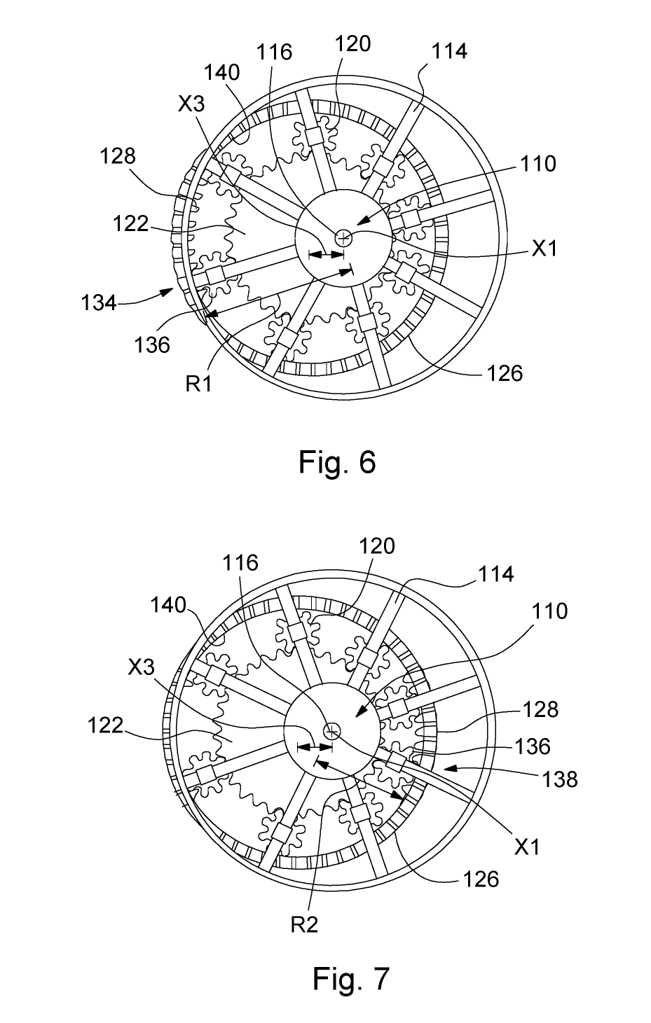

In turn, a plurality of planetary gears 120 are mounted on axially extending portions of the support shafts 118 such that one of the planetary gears 120 is mounted on each of the support shafts 118 about axes parallel to the first axis X1. The planetary gears 120 mesh with a second or spur gear 122 such that the planetary gears 120 rotate around the second gear 122 as the first gear 110 is rotated. The second gear 122 has a second axis X2 that is parallel to and at a fixed offset X3 (illustrated in FIGS. 6 and 7) from the first axis X1. The offset X3 results in the planetary gears 120 rotating in an elliptical orbit around the first axis X1 and a circular orbit around the second axis X2. As the second gear 122 rotates, each of the planetary gears 120 will mesh with the teeth 128 in turn and as a result drive the first gear 110 such that torque is transferred from the second gear 122 to the first gear 110 and vice versa.

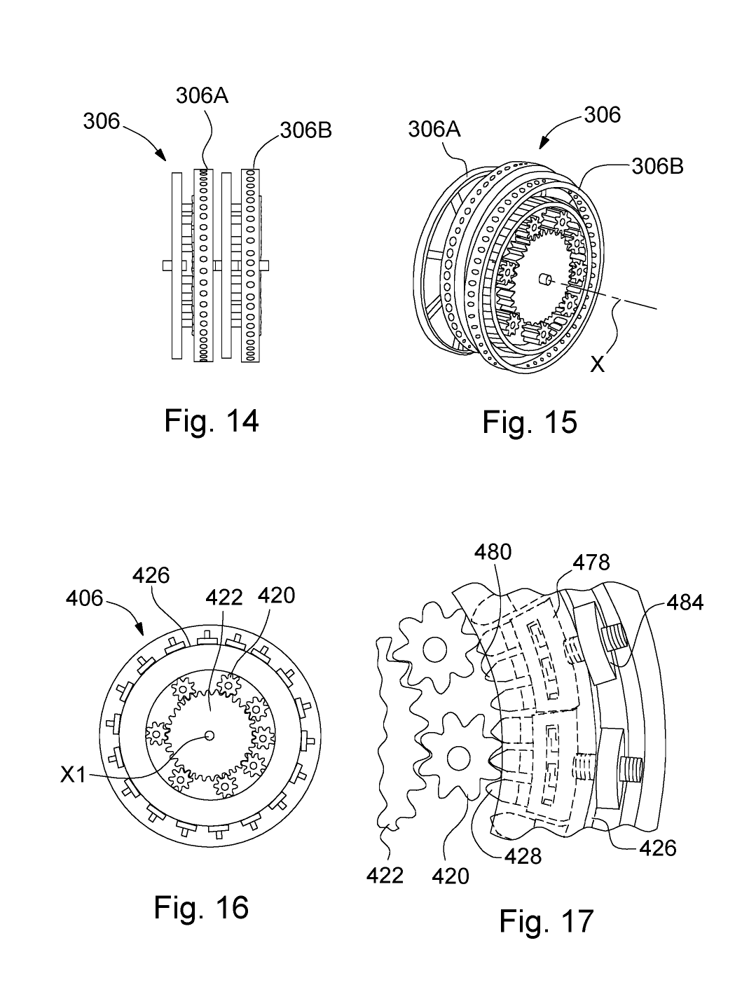

Extending axially from the second gear 122 is a second shaft 124, which may be supported for rotation by bearings (not illustrated). The second shaft 124 may be an input shaft for the transmission 106 and receive power from the power source 104. A ring gear, indicated generally at 126, has ring gear teeth 128 that selectively mesh with the planetary gears 120. Alternatively, the transmission 106 may include a second assembly which may include a second spoke gear, a second plurality of support shafts, a second plurality of planetary gears, a second spur gear, and a second ring gear, connected to one of the power source 104 and driving the wheels 108, with the two assemblies connected in series to allow for a greater range of gear ratios (see FIGS. 14 and 15).

FIG. 5 illustrates bearings 130 mounted on the support shafts 118. The bearings 130 bear on a guide ring 132, which is concentric with the second axis X2. The guide ring 132 keeps the planetary gears 120 meshed with the second gear 122 (only a portion of the second gear 122 is illustrated for clarity).

FIGS. 6 and 7 illustrate the teeth 128 selectively meshing with the planetary gears 120 to set a gear ratio between the first and second gears 110 and 122, respectively. In FIG. 6, the transmission 106 is illustrated in a first position 134. In the first position 134, an exemplary planetary gear 136 meshes with the teeth 128 at a first distance R1 from the first shaft 116. The teeth 128 mesh with the exemplary gear 136 in the first position 134. In FIG. 7, the transmission 106 is in a second position 138, which is varied from the first position 134 in FIG. 6 by rotating the ring gear 126. In the second position 138, the first gear 110 has rotated and the exemplary gear 136 now meshes with the teeth 128 at a second distance R2 from the first shaft 116. As will be discussed, the ring gear 126 may be rotated to move the teeth 128 between the first and second positions 134 and 138, respectively, and stop anywhere in between those positions as well in order to allow for continuously varying the gear ratio. Only one or two of the planetary gears 120 at a time fully meshes with the teeth 128. Accordingly, one will note that the teeth 128 may only be located over a small portion of a circumference 140 of the ring gear 126.

The gear ratio between the first and second gears 110 and 122 is set as a function of the distance—e.g., the first or second distances R1 or R2—from the first shaft 116 to a mesh point between the planetary gears 120 and teeth 128. For the same rotational speed of the second gear 122, the first gear 110 will rotate slower in the first position 134 than the second position 138 because the first distance R1 is greater than the second distance R2. Thus, the gear ratio between the first and second gears 110 and 122, respectively, may be set to different values by changing a position of the teeth 128 on the circumference 140 of the ring gear 126 by rotating the ring gear 126. Changing where on the circumference 140 the teeth 128 mesh with the planetary gears 120 subsequently changes the distance between the first shaft 116 and the mesh point. Changing the distance between the first shaft 116 and the mesh point in turn sets the gear ratio between the first and second gears 110 and 122, respectively.

The first and second positions 134 and 138, respectively, are merely representative. The teeth 128 may selectively mesh with the planetary gears 120 at any position on the ring gear 126 (by rotating the ring gear 126) to set the gear ratio between the first and second gears 110 and 122, respectively. Other geometry of the transmission 106 may be altered during manufacturing of the transmission 106 to change a range of gear ratios that may be produced by the transmission 106. For example, the offset X3 may be fixed at different lengths during manufacturing of the transmission 106. Furthermore, the first and second distances R1 and R2 may be measured as other than from the first shaft 116 to the mesh point. For example, the first and second distances R1 and R2 may be measured from the hub 112 to the mesh point, from the first shaft 116 to an axis of the exemplary gear 136, or from the hub 112 to the axis of the exemplary gear 136.

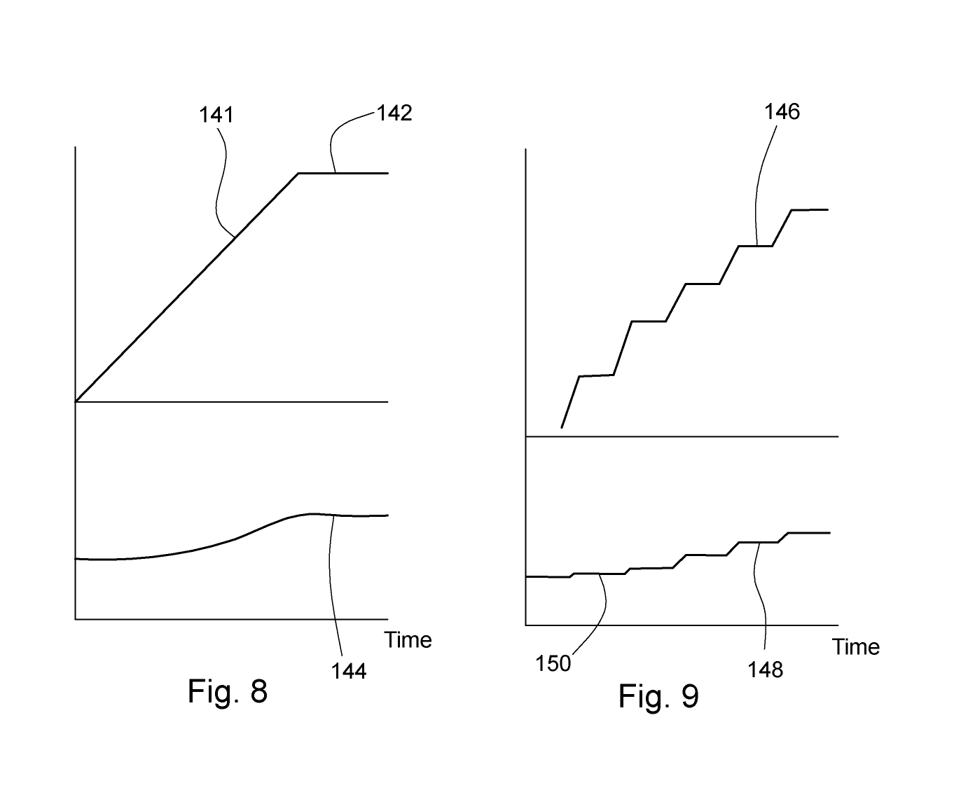

FIG. 8 illustrates a mode of operation of the transmission 106 wherein the gear ratio is continually set—i.e., changed—at a constant rate (by rotating the ring gear 126 at a constant rate 141 until it is stopped at 142) from a first gear ratio to a last gear ratio. The constant rate 141 of rotation of the ring gear 126 produces a non-stepped speed 144 change of the first shaft 116 relative to the second shaft 124. The gear ratio is varied by the teeth 128 meshing with the planetary gears 120—e.g., from the first position 134 to the second position 138—in a continual, single movement.

FIG. 9 illustrates an additional mode of operation of the transmission 106 wherein the rotation of the ring gear 126 is a stepped rate 146 from the first gear ratio to the last gear ratio. The stepped rate 146 produces a speed 148 of the first shaft 116 relative to the second shaft 124 that increases in steps or plateaus. The gear ratio is changed at the stepped rate 146 due to the teeth 128 meshing with the planetary gears 120 at a different circumferential location—e.g., from the first position 134 to the second position 138—in a stepped manner. Constant speed periods 150 are achieved by the teeth 128 meshing with the planetary gears 120 at specific positions on the circumference 140. In the additional mode of operation, only one of the planetary gears 120 is meshed with the teeth 128 at a time. The gear ratio is set for different values by changing where on the circumference 140 meshing between the planetary gears 120 and second gear 122 occurs—e.g., at the first or second position 134 or 138, respectively, or another position.

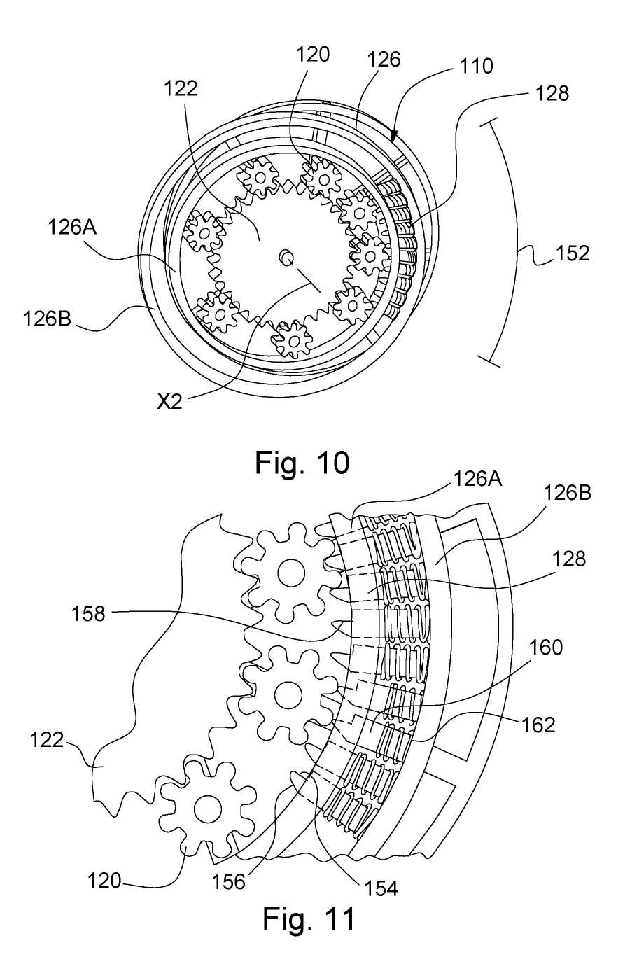

FIGS. 10-12 illustrate selective meshing of the teeth 128 with the planetary gears 120 over only a portion 152 of the ring gear 126 by rotating the ring gear 126. As illustrated, the teeth 128 are held between inner and outer ring gears 126A and 1268, respectively. Each of the teeth 128 has a flat face 154 and a curved face 156, opposite the flat face 154. When the planetary gears 120 contact the flat face 154 of an exemplary tooth of the teeth 128, the exemplary tooth remains in an extended position and the planetary gears 120 drive or rotate the first gear 110. When the planetary gears 120 contact the curved face 156 of the exemplary tooth, the exemplary tooth moves to a retracted position 160 against the bias of a spring 162, and the first gear 110 is not driven. Springs 162 are biased to push the teeth 128 radially inward, returning the teeth 128 from the retracted position 160 to the extended position 158. The flat and curved faces 154 and 156, respectively, result in one-way operation of the transmission 106. Pairing the teeth 128 with a second set of teeth (not illustrated) in the ring gear 126, wherein the second set of teeth has flat and curved faces oriented oppositely from the teeth 128, allows two-way operation of the transmission 106—i.e., torque transfer from the first gear 110 to the second gear 122 or from the second gear 122 to the first gear 110.

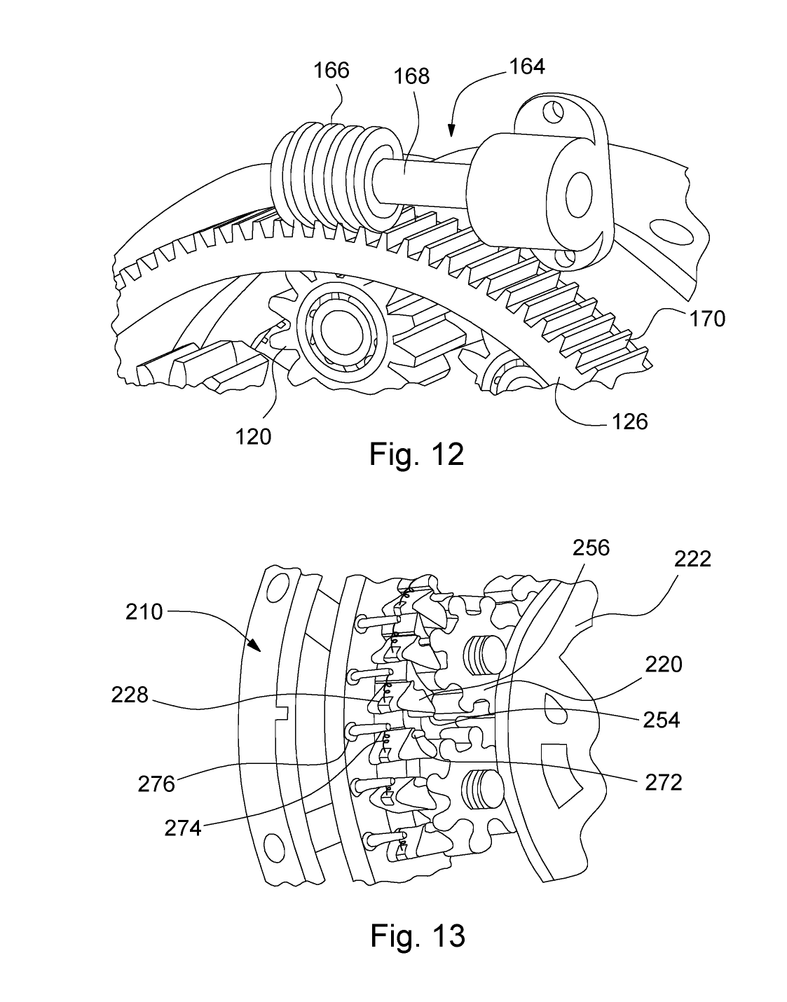

FIG. 12 illustrates an electric motor, indicated generally at 164, for rotating the ring gear 126 to selectively mesh the teeth 128 with the planetary gears 120. The motor 164 may be controlled by the controller 105 (illustrated in FIG. 1). For example, the motor 164 may rotate the ring gear 126 to move the teeth 128 back and forth between the first and second positions 134 and 138, respectively. The motor 164 may drive a worm 166 on a motor shaft 168. The worm 166 meshes with external teeth 170 on the ring gear 126 to rotate the ring gear 126 when the motor 164 operates. The motor 164 is actuated to change the gear ratio between the first and second shafts 116 and 124, respectively. When it is desired to maintain the current ratio, the motor 164 may be off. Alternatively, the ring gear 126 may be rotated by means other than the motor 164, such as for example employing hydraulic controls.

FIG. 13 illustrates teeth 228. Because the teeth 228 are a variation of the teeth 128 in FIGS. 10 and 11, like reference numerals, incremented by 100, designate corresponding parts in the drawings and detailed description thereof will be omitted.

The teeth 228 individually move—i.e., rotate or pivot—about pivots 272 between retracted and extended positions. The teeth 228 are returned from the retracted position to the extended position by springs 274 between the teeth 228 and pins 276. In the retracted position, the retracted tooth 228 will not engage the planetary gear teeth.

FIGS. 14 and 15 illustrate a variation of transmission 106 of FIG. 1. Because transmission 306 is a variation of the transmission 106 in FIGS. 1-12, like reference numerals, incremented by 200, designate corresponding parts in the drawings and detailed description thereof will be omitted.

The transmission 306 comprises first and second transmissions 306A and 306B, respectively, coupled in tandem—i.e., an output shaft of the first transmission 306A is an input shaft of the second transmission 306B—to increase a range of gear ratios that the transmission 306 may produce. A single control mechanism may be used for both the first and second transmissions 306A and 306B, respectively, in which ring gears of the first and second transmissions 306A and 306B, respectively, are rotated in a coordinated manner. The controller 105 may control the rotation of the ring gears of the first and second transmissions 306A and 306B, respectively.

FIGS. 16 and 17 illustrate a variation of transmission 106. Because transmission 406 is a variation of the transmission 106 in FIGS. 1-12, like reference numerals, incremented by 300, designate corresponding parts in the drawings and detailed description thereof will be omitted.

The variation from the first embodiment relates to the fact that a ring gear 426 is kept stationary while teeth 428 may be provided on a full circumference of the ring gear 426. This allows for a broader range of gear ratios. The teeth 428 are arranged into tooth arrays 478. To selectively mesh the teeth 428 with planetary gears 420, arrays 478 are moved from a retracted position 480 to an extended position 482 such that the teeth 428 in the arrays 478 mesh with the planetary gears 420 when in the extended position 482. The arrays 478 are moved between the retracted and extended positions 480 and 482, respectively, by motors 484. The motors 484 may be controlled by the controller 105 (see FIG. 1). A first position sensor is provided on a first gear to track positions of the planetary gears 420. A second position sensor may also be provided on the ring gear 426. Use of both the first and second position sensors allows the teeth 428 to be provided on only a portion of the ring gear 426 if a smaller range of gear ratios is desired. The configuration of the transmission 406 allows two-way torque transmission: from a first gear 410 to a second gear 422 and from the second gear 422 to the first gear 410. Thus torque can flow from the power source 104 to the wheels 108, and from the wheels 108 to the power source 104. This can be useful when employed in vehicles with, for example, regenerative braking, engine braking, etc.

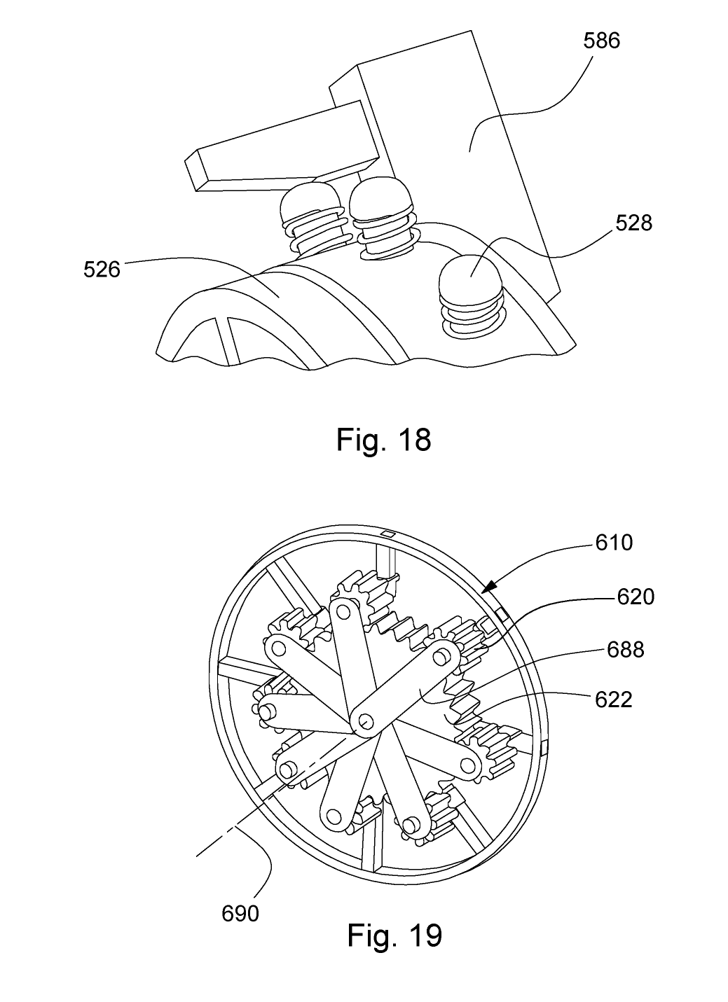

FIG. 18 illustrates a ring gear 526. Because the ring gear 526 is a variation of the ring gear 426 in FIGS. 16 and 17, like reference numerals, incremented by 100, designate corresponding parts in the drawings and detailed description thereof will be omitted.

Teeth 528 are moved individually between extended and retracted positions by individual wedge cams 586 (only one of which is illustrated). Each of the teeth 528 is actuated by one of the wedge cams 586. Similar to the ring gear 426, the ring gear 526 allows two-way torque transfer. Electric or hydraulic control of the wedge cams 586 may be employed, and controlled by the controller 105.

FIG. 19 illustrates planetary gears 620. Because the planetary gears 620 are a variation of the planetary gears 120 in FIGS. 1-12, like reference numerals, incremented by 500, designate corresponding parts in the drawings and detailed description thereof will be omitted.

The planetary gears 620 are held meshed with a second gear 622 by struts 688. The struts 688 extend between the planetary gears 620 and an axis 690 of the second gear 622.

While the embodiments of the continuously variable transmission described herein are in the context of transmissions for automotive vehicles, the continuously variable transmission may also be used for other small or compact devices or machines including bicycles, e-bikes, milling machines, power window mechanisms, or household appliances such as clothes washers or dryers

While certain embodiments of the present invention have been described in detail, those familiar with the art to which this invention relates will recognize various alternative designs and embodiments for practicing the invention as defined by the following claims.

What is claimed is:

1. A transmission comprising:
a first gear rotatable about an axis;
shafts, each shaft extending axially parallel to the axis and being radially slidable on the first gear;
a second gear rotatable about a second axis parallel to and at a fixed offset from the axis;
planetary gears, each planetary gear mounted on and rotatable about a respective one of the shafts and meshing with the second gear;
a ring gear coaxial with the second gear and having teeth that selectively mesh with less than all of the planetary gears at a time and are adjustable to change a distance from the axis to the teeth to changeably set a gear ratio between the first and second gears.

2. The transmission of claim 1 further comprising:
a first gear ratio wherein the planetary gears mesh with the teeth at a first distance from the axis;
a second gear ratio wherein the planetary gears mesh with the teeth at a second distance from the axis, wherein the second distance is different than the first distance.

3. The transmission of claim 1 further comprising:
a circumference of the ring gear, wherein the teeth selectively mesh with the planetary gears around the circumference.

4. The transmission of claim 1 further comprising:
spokes extending radially from a hub of the first gear, wherein each of the shafts is mounted on a respective one of the spokes and is radially slidable on the respective one of the spokes.

5. The transmission of claim 1 wherein the teeth of the ring gear are selectively rotatable on pivots in the ring gear to selectively engage the planetary gears.

6. The transmission of claim 1 wherein the teeth are located only over a portion of a circumference of the ring gear and the ring gear is rotated to selectively mesh the teeth with the planetary gears to thereby change the gear ratio of the transmission.

7. The transmission of claim 6 wherein the ring gear is rotated by an electric motor.

8. The transmission of claim 6 wherein the ring gear is held stationary to maintain the gear ratio.

9. The transmission of claim 1 wherein the ring gear is rotationally fixed and the teeth each have:
an extended position in which the teeth mesh with the planetary gears;
a retracted position in which the teeth do not mesh with the planetary gears;
a controller configured to selectively extend and retract selective teeth.

10. The transmission of claim 9 further comprising:
wedge cams, each actuating a respective one of the teeth between the extended and retracted positions in response to the controller.

11. The transmission of claim 9 further comprising:
a position sensor mounted to the first gear for detecting a relative position of the first gear relative to the axis.

12. The transmission of claim 1 further comprising:
bearings, wherein each of the bearings is mounted on the respective one of the shafts;
a guide ring, concentric with the second axis, wherein the guide ring bears on the bearings to keep the planetary gears meshed with the second gear.

13. The transmission of claim 1 further comprising:
struts, wherein each of the struts is mounted between the respective one of the shafts and the axis such that the struts keep the planetary gears meshed with the second gear.

14. The transmission of claim 1 wherein each of the teeth has:
a flat face facing in a first circumferential direction;
a curved face opposite the flat face, such that the planetary gears engage the flat face to transfer torque in a first rotational direction, and the planetary gears engage the curved face in a second rotational direction that moves the tooth radially outward to prevent torque transfer.

15. The transmission of claim 1 further comprising:
an electric motor having a motor shaft;
a worm driven by the motor shaft, wherein the worm meshes with external teeth on the ring gear to rotate the ring gear and selectively mesh the teeth with the planetary gears;
a controller controlling the motor to rotate the ring gear.

16. The transmission of claim 1 further comprising:
a circumference of the ring gear, wherein the teeth are only over a portion of the circumference and are radially retractable;
springs for each of the teeth, wherein the springs bias the teeth radially inward.

17. The transmission of claim 1 further comprising:
tooth arrays, wherein the teeth are arranged into the tooth arrays;
motors for each of the tooth arrays, wherein the motors move the tooth arrays between retracted positions that do not mesh the teeth with the planetary gears and extended positions in which the teeth mesh with the planetary gears;
a controller controlling the motors.

18. A transmission comprising:
a first gear rotatable about a first axis;
spokes extending radially from the first gear,
shafts, each shaft extending axially parallel to the first axis and being mounted on, and radially slidable on, a respective one of the spokes;
a second gear rotatable about a second axis parallel to, and at a fixed offset from, the first axis;
planetary gears, each mounted on and rotatable about a respective one of the shafts and meshing with the second gear;
a ring gear coaxial with the second gear and having teeth, wherein the ring gear is rotated to selectively mesh the teeth with less than all of the planetary gears at a time and to change a distance from the first axis to the teeth to changeably set a gear ratio between the first and second gears.

19. A transmission comprising:
a first gear rotatable about a first axis;
spokes extending radially from the first gear,
shafts, each shaft extending axially parallel to the first axis and being mounted on, and radially slidable on, a respective one of the spokes;
a second gear rotatable about a second axis parallel to, and at a fixed offset from, the first axis;
planetary gears, each mounted on and rotatable about a respective one of the shafts and meshing with the second gear;
a ring gear coaxial with the second gear and having teeth, wherein the ring gear is rotationally fixed and the teeth each have:
an extended position in which the teeth mesh with the planetary gears;
a retracted position in which the teeth do not mesh with the planetary gears;
a controller configured to selectively extend and retract selective teeth to selectively mesh the teeth with less than all of the planetary gears at a time to change a distance from the first axis to the teeth to changeably set a gear ratio between the first and second gears.

20. An automotive transmission comprising:
a first spoke gear rotatable about a first axis;
first shafts, each first shaft extending axially parallel to the first axis and being radially slidable on the first spoke gear;
a first spur gear rotatable about a second axis parallel to, and at a fixed offset from, the first axis;
first planetary gears, each mounted on and rotatable about a respective one of the first shafts and meshing with the first spur gear;
a first ring gear coaxial with the first spur gear and having first teeth that selectively mesh with less than all of the first planetary gears at a time and adjustable to change a first distance from the first axis to the first teeth to changeably set a first gear ratio between the first spoke gear and first spur gear;
a second spoke gear rotatable about the second axis;
second shafts, each second shaft extending axially parallel to the second axis and being radially slidable on the second spoke gear;
a second spur gear rotatable about a third axis parallel to, and at a fixed offset from, the second axis;
second planetary gears, each mounted on and rotatable about a respective one of the second shafts and meshing with the second spur gear;
a second ring gear coaxial with the second spur gear and having second teeth that selectively mesh with less than all of the second planetary gears at a time and adjustable to change a second distance from the second axis to the second teeth to changeably set a second gear ratio between the second spoke gear and second spur gear, wherein the second spoke gear drives the first spur gear and an overall gear ratio for the transmission is a product of the first and second gear ratios.

21. A transmission comprising:
a first gear on a first shaft;
a second gear on a second shaft at a parallel, fixed offset from the first shaft;
planetary gears slidably mounted on the first gear and rotatably meshing with the second gear;
a ring gear coaxial with the first gear and rotated to selectively mesh teeth on the ring gear with the planetary gears and change a distance from the first shaft to the teeth.
